(19) United States
(12) Patent Application Publication
(10) Pub. No.: US 2016/0117875 A1
(43) Pub. Date: Apr. 28, 2016

(54) METHOD FOR USING A SENSOR TO DETECT A USER'S PRESENCE FOR UNLOCKING AN ACCESS TO A MOTOR VEHICLE, AND SENSOR ASSOCIATED THEREWITH

(71) Applicants: CONTINENTAL AUTOMOTIVE FRANCE, Toulouse (FR); CONTINENTAL AUTOMOTIVE GmbH, Hannover (DE)

(72) Inventor: Christophe DUCHEMIN, Toulouse (FR)

(21) Appl. No.: 14/920,190

(22) Filed: Oct. 22, 2015

(30) Foreign Application Priority Data
Oct. 28, 2014 (FR) 1460359

(51) Int. Cl. G07C 9/00

(52) U.S. Cl. CPC G07C 9/00126

(57) ABSTRACT

A method for detecting a user's presence for unlocking an access to a motor vehicle, uses a sensor which performs the detection in an acquisition phase and a measurement phase. The method is remarkable in that the acquisition phase and the measurement phase are concomitant.

### FIELD OF THE INVENTION

The present invention relates to the field of motor vehicles; more particularly, it concerns the unlocking of an access to a motor vehicle. Accordingly, the invention proposes a method for using a sensor to detect a user's presence for unlocking access to a motor vehicle, a sensor associated therewith, and a motor vehicle comprising this sensor.

### BACKGROUND OF THE INVENTION

In motor vehicles, there is a known method of using an access unlocking system comprising a sensor for detecting a user's presence. In a known way, this sensor takes the form of a capacitive proximity sensor which can be used to detect, for example, the presence of a user's hand on a door handle, for the purpose of unlocking the door, or to detect the passage of a user's foot under the trunk of the vehicle, for the purpose of opening the trunk at least partially.

The example of FIG. 1 shows the unlocking of a vehicle door (not shown) by a user, with the aid of a presence detection sensor 1 housed in the door handle 2. When the user moves his hand M from a first position P1, remote from the handle 2, to a second position P2, on the handle 2, the sensor 1 detects this presence, resulting in the unlocking of the door.

For this purpose, the detection sensor 1 comprises, in a known way, a first electrode 3 connected to a printed circuit 4, comprising a capacitor Cx, called a detection capacitor, and a capacitor Cs, called a storage capacitor. When the user's hand M is in the second position P2 near the electrode 3, the user acts as a second electrode, connected to ground, which increases the capacitance of the detection capacitor Cx to a level greater than the nominal capacitance of the detection capacitor Cx “at rest” (i.e. if no user is present).

A sensor of an existing solution, shown in detail in FIG. 2, comprises a supply voltage generator Vcc, a first electrical circuit A1, a second electrical circuit B1, and voltage comparison means COMP.

The first electrical circuit A1 comprises a first electrode, represented by a detection capacitor Cx, a storage capacitor Cs defining a storage voltage Vs at its terminals, a measuring resistor Rs and three two-position switches T1, T2 and Ts. The first switch T1 is positioned between the positive terminal of the voltage generator Vcc and a first terminal of the detection capacitor Cx. The second switch T2 is placed between the first terminal of the detection capacitor Cx and a first terminal of the storage capacitor Cs, the second terminals of each of the detection capacitor Cx and the storage capacitor Cs respectively and the negative terminal of the voltage generator Vcc being connected to a ground G. The third switch Ts is placed between the positive terminal of the voltage generator Vcc and a first terminal of the measuring resistor Rs, whose second terminal is connected to the first terminal of the storage capacitor Cs.

The second electrical circuit B1 comprises a bridge for dividing the supply voltage Vcc, formed by a first reference resistor Rref1, a second reference resistor Rref2 and a reference capacitor Cref which is also connected to the ground G, defining a reference voltage Vref.

The comparison means COMP take the form of a voltage comparator connected so as to compare the storage voltage Vs at the terminals of the storage capacitor Cs with the reference voltage Vref at the terminals of the reference capacitor Cref.

In order to detect a user's presence, the sensor operates alternately in a first phase, called the acquisition phase, and a second phase, called the measurement phase.

The acquisition phase comprises a predetermined number nx of cycles for charging the storage capacitor Cs, this capacitor being discharged at the start of the acquisition phase. If no user is present near the sensor, the storage capacitor Cs is charged with a nominal charge defining a nominal storage voltage Vs_nom at the terminals of the storage capacitor Cs. This sensor is called a “low consumption linear charge-transfer sensor”.

A cycle comprises four steps providing a linear charge transfer between the voltage generator Vcc and the storage capacitor Cs via the detection capacitor Cx. In the initial state of the circuit, the three switches T1, T2 and Ts are open. The third switch Ts remains open during the four steps of the acquisition phase. In a first step, called the charge step, the first switch T1 is closed and the second switch T2 is open, enabling the detection capacitor Cx to be charged by the voltage generator Vcc. In a second step, called the rest step, the first switch T1 and the second switch T2 are open simultaneously. In a third step, called the discharge step, the first switch T1 is open and the second switch T2 is closed, enabling the charge to be transferred by current conduction from the detection capacitor Cx to the storage capacitor Cs. Finally, in a fourth step, which is a rest step, the first switch T1 and the second switch T2 are again open simultaneously, as shown in FIG. 2.

When the storage capacitor Cs has been charged for a predetermined number nx of cycles without a user coming near the sensor, the charge of the storage capacitor Cs at the end of the acquisition phase is equal to the nominal charge, and the storage voltage at the terminals of the storage capacitor Cs is equal to the nominal storage voltage Vs_nom at the end of the acquisition phase.

On the other hand, if a user is present near the sensor during the acquisition phase, the capacitance of the detection capacitor Cx increases, and the charge of the storage capacitor Cs at the end of the acquisition phase is equal to a detection charge which is greater than the nominal charge. In this case, the voltage at the terminals of the storage capacitor at the end of the acquisition phase is equal to a detection voltage Vs_det which is greater than the nominal storage voltage Vs_nom.

During the measurement phase, the first switch T1 and the second switch T2 being open, the third switch Ts is closed so as to charge the storage capacitor Cs through the measuring resistor Rs, until the comparator indicates that the storage voltage Vs has reached the reference voltage Vref, and the time elapsed between the instant of closure of the third switch Ts and the instant when the storage voltage Vs reaches said reference voltage Vref is then measured.

If no user is present near the sensor during the acquisition phase, the time measured between the instant of closure of the third switch Ts (when the storage voltage Vs is equal to the nominal voltage Vs_nom) and the instant at which the storage voltage Vs reaches the reference voltage Vref is equal to a nominal time Tnom. In other words, if there is no detection, the storage voltage Vs reaches the reference voltage Vref after a nominal time Tnom.

In the presence of a user near the sensor during the acquisition phase, the time measured between the instant of closure of the third switch Ts (when the storage voltage Vs is equal to a detection voltage Vs_det, greater than the nominal voltage Vs_nom) and the instant at which the storage voltage Vs reaches the reference voltage Vref is equal to a detection time Tdet which is shorter than the nominal time Tnom, indicating the detection of the presence of a user near the sensor electrode. In other words, if a presence is detected, the storage voltage Vs reaches the reference voltage Vref more quickly during the measurement phase.

Since a user has been detected, the sensor sends a detection signal to an electronic computer of the vehicle, referred to in a known way as an ECU (Electronic Control Unit in English), which then unlocks the corresponding access to the vehicle, after authentication if required.

In this solution, the succession of the predetermined number nx of cycles of the acquisition phase followed by the measurement phase may prove to be time-consuming, thus increasing the time required for detection and unlocking the access, which is a considerable drawback.

### SUMMARY OF THE INVENTION

The invention therefore aims to overcome this drawback by proposing a simple, reliable, fast and effective solution for reducing the time required to detect a user's presence for unlocking an access to a vehicle.

To this end, the invention proposes a method for using a sensor to detect a user's presence for unlocking an access to a motor vehicle, said sensor comprising:
a supply voltage generator,
a first electrical circuit comprising a capacitor for detecting a user's presence, which defines a detection voltage at its terminals, a storage capacitor which defines a storage voltage at its terminals, means for controlling the charging of the detection capacitor using the supply voltage, means for controlling the discharging of the detection capacitor into the storage capacitor, and means for calibrating a charging current of the storage capacitor generated using the supply voltage,
a second electrical circuit comprising a reference capacitor defining a reference voltage at its terminals and a bridge circuit for dividing the supply voltage into the reference voltage,
means for comparing said storage voltage and said reference voltage in order to detect a user's presence for unlocking an access to the motor vehicle,

said method comprising an acquisition phase during which a step of charging the detection capacitor and a step of discharging said detection capacitor into the storage capacitor are repeated successively for a predetermined number nx of times, and a measurement phase comprising a step of charging the storage capacitor using the supply voltage, the method being remarkable in that the acquisition phase and the measurement phase are concomitant.

By executing the acquisition phase and the measurement phase simultaneously, the time required for detecting a user's presence can be reduced considerably, since both phases are executed in parallel.

Also preferably, when the sensor comprises a digital-analog converter (abbreviated to DAC in English), the method comprises a step in which the reference voltage is determined by said digital-analog converter, in such a way that this voltage is always greater than the storage voltage at the end of the predetermined number nx of discharges of the detection capacitor into the storage capacitor. Advantageously, the difference between the reference voltage and the storage voltage after the predetermined number nx of discharges is less than 100 mV. The use of a digital-analog converter therefore makes it possible to dynamically define the reference voltage to be reached in order to overcome the drift of the components, notably that of the capacitance of the detection capacitor, and to minimize the measurement time of the sensor. The invention also concerns a sensor for detecting a user's presence for unlocking an access to a motor vehicle, said sensor comprising:
a supply voltage generator,
a first electrical circuit comprising a capacitor for detecting a user's presence, which defines a detection voltage at its terminals, a storage capacitor which defines a storage voltage at its terminals, means for controlling the charging of the detection capacitor using the supply voltage, means for controlling the discharging of the detection capacitor into the storage capacitor, and means for calibrating a charging current of the storage capacitor generated using the supply voltage,
a second electrical circuit, comprising a reference capacitor defining a reference voltage at its terminals and a bridge circuit for dividing the supply voltage into the reference voltage, and
means for comparing said storage voltage and said reference voltage in order to detect a user's presence for unlocking an access to the motor vehicle,

the sensor being remarkable in that the calibration means take the form of a measuring resistor, preferably a single resistor, continuously connected electrically, on the one hand, to the supply voltage generator, and, on the other hand, to the storage capacitor.

The absence of a switch between the supply voltage generator and the measuring resistor enables the acquisition phase and the measurement phase to be executed simultaneously, thereby advantageously reducing the time required for detecting the presence of a user near the sensor, while retaining a similar sensitivity of the sensor. Furthermore, the absence of a switch between the supply voltage generator and the measuring resistor enables the complexity, and therefore the cost, of the sensor to be reduced.

Preferably, the calibration means consist of a measuring resistor, preferably a single resistor, continuously connected electrically, on the one hand, to the supply voltage generator, and, on the other hand, to the storage capacitor.

Also preferably, the sensor comprises a digital-analog converter (abbreviated to DAC in English), configured to determine the reference voltage in such a way that this voltage is always greater than the storage voltage at the end of the predetermined number nx of discharges of the detection capacitor into the storage capacitor.

The invention also proposes a motor vehicle comprising a sensor such as that described above.

### BRIEF DESCRIPTION OF THE DRAWINGS

Other characteristics and advantages of the invention will be apparent from the following description, which refers to the attached drawings, provided by way of non-limiting examples, in which identical references are given to similar objects.

FIG. 1 (described above) shows schematically the unlocking of a motor vehicle door by the detection of the presence of a user's hand.

FIG. 2 (described above) shows an embodiment of a prior art sensor.

FIG. 3 shows an embodiment of a sensor according to the invention.

FIG. 4 shows the variations of the storage voltage Vs and the reference voltage Vref during a cycle of an acquisition phase of the sensor of FIG. 3.

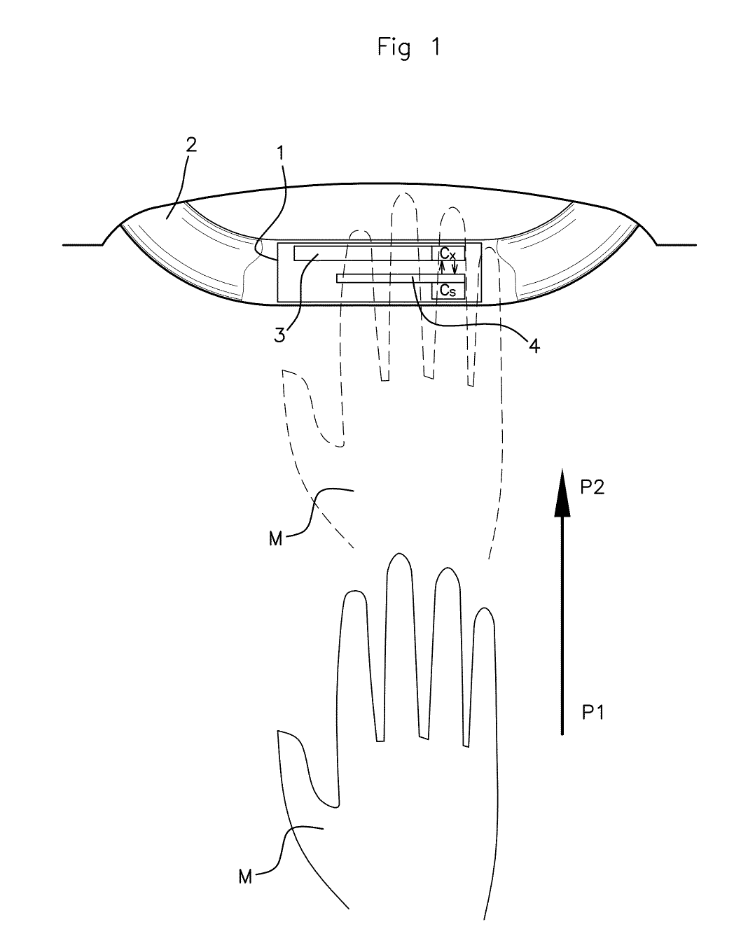

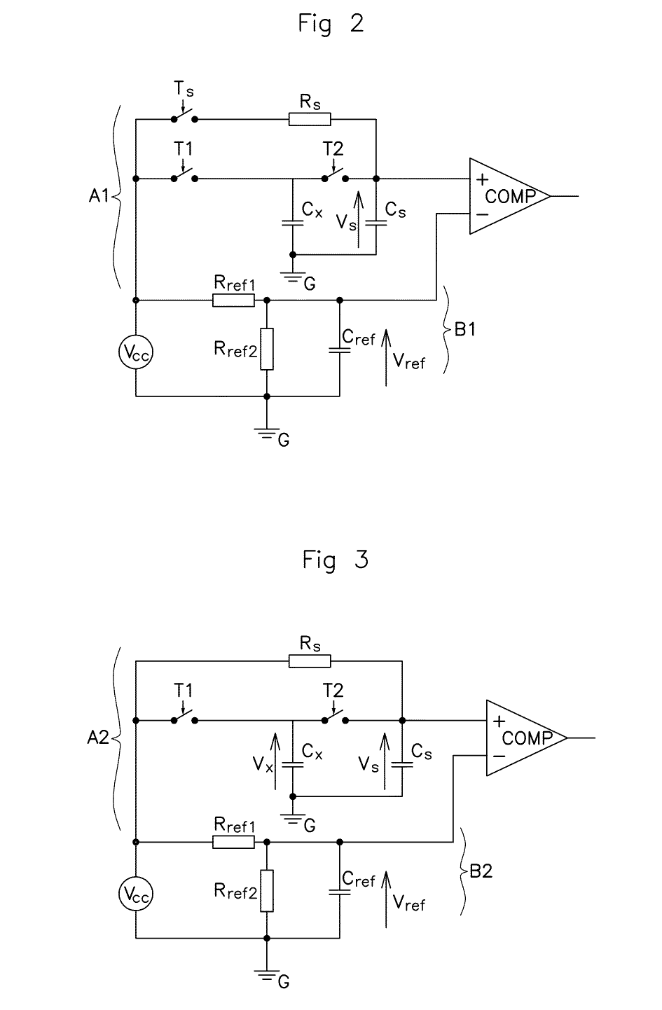

### DETAILED DESCRIPTION OF THE INVENTION

The sensor according to the invention is intended to be fitted in a motor vehicle to allow the unlocking of one of the accesses to the vehicle, for example the trunk or a door. An embodiment of the sensor is described below with reference to FIG. 3.

The detection sensor comprises a generator of a continuous supply voltage Vcc, for example 5 V, a first electrical circuit A2, a second electrical circuit B2, and voltage comparison means COMP.

The first electrical circuit A2 comprises a detection capacitor Cx for detecting a user's presence, forming, at least partially, the first electrode; a storage capacitor Cs; means for controlling the charging of the detection capacitor Cx using the supply voltage Vcc; means for controlling the discharging of the detection capacitor Cx into the storage capacitor Cs; and means for controlling the charging of the storage capacitor Cs using the supply voltage Vcc.

The first electrode extends in an element of the vehicle, for example a handle, in such a way that part of a user's body, forming a second electrode connected to ground, can approach the first electrode and thereby increase the capacitance of a detection capacitor Cx.

The detection capacitor Cx defines a detection voltage Vx at its terminals, and the storage capacitor Cs defines a storage voltage Vs at its terminals, using the detection voltage Vx.

In this example, the means for controlling the charging of the detection capacitor Cx using the supply voltage Vcc take the form of a first two-position switch T1 connected, on the one hand, to the positive terminal of the supply voltage generator Vcc, and, on the other hand, to a first terminal of the detection capacitor Cx. The first switch T1 is configured to switch between a closed position, in which it allows the flow of an electric current generated by the supply voltage Vcc, and an open position, in which it prevents the flow of an electric current generated by the supply voltage Vcc.

In this example, the means for controlling the discharge of the detection capacitor Cx into the storage capacitor Cs take the form of a second switch T2 connected, on the one hand, to the first terminal of the detection capacitor Cx, and, on the other hand, to a first terminal of the storage capacitor Cs. The second switch T2 is configured to switch between a closed position, in which it allows the flow of an electric current generated by the discharge of the detection capacitor Cx, and an open position, in which it prevents the flow of an electric current.

The second terminals of each of the detection capacitor Cx and the storage capacitor Cs, together with the negative terminal of the voltage generator Vcc, are connected to a ground G.

Preferably, the first switch T1 and the second switch T2 are controlled by a microcontroller (not shown).

In this example, the means for controlling the charging of the storage capacitor Cs from the supply voltage Vcc take the form of a single measuring resistor Rs which is continuously electrically connected, on the one hand, by its first terminal, to the positive terminal of the supply voltage generator Vcc, and, on the other hand, by its second terminal, to the first terminal of the storage capacitor Cs. This measuring resistor Rs allows the storage capacitor Cs to be charged from the voltage generator Vcc until the storage voltage Vs reaches the value of a reference voltage Vref described below.

By way of example, the values of the detection capacitor Cx, the storage capacitor Cs and the measuring resistor Rs may be as follows:

Cx=70 pF

Cs=30 nF

Rs=430 kΩ

The second electrical circuit B2 comprises a reference capacitor Cref defining a reference voltage at its terminals and a bridge circuit for dividing the supply voltage Vcc.

The bridge circuit enables the supply voltage Vcc to be divided into the reference voltage Vref. For this purpose, the bridge circuit comprises a first reference resistor Rref1 and a second reference resistor Rref2. The first reference resistor Rref1 is connected, on the one hand, by its first branch, to the positive terminal of the supply voltage generator Vcc, and, on the other hand, by its second branch, to a first branch of the reference capacitor Cref. The second reference resistor Rref2 is connected, on the one hand, by its first branch, to the first branch of the reference capacitor Cref, and, on the other hand, by its second branch, to the ground G. The second branch of the reference capacitor Cref is connected to the ground G.

It should be noted that the aforementioned digital-analog converter may replace the first reference resistor Rref1 and the second reference resistor Rref2, so that the reference voltage is adjustable by software programming.

By way of example, the values of the reference capacitor Cref, the first reference resistor Rref1 and the second reference resistor Rref2 may be as follows:

Cref=10 nF

Rref1=47 kΩ

Rref2=47 kΩ

The voltage comparison means COMP are configured for comparing the storage voltage Vs and the reference voltage Vref in order to detect a user's presence, to enable an access to the motor vehicle to be unlocked when the two voltages are equal. In a known way, the comparison means COM may take the form of a voltage comparator.

Optionally, the sensor may comprise a digital-analog converter (abbreviated to DAC in English), configured to determine the reference voltage Vref in such a way that this voltage is always greater than the storage voltage Vs at the end of the predetermined number nx of discharges of the detection capacitor Cx into the storage capacitor Cs.

In order to detect a user's presence, the sensor operates in a phase called the acquisition phase and in a second phase called the measurement phase. According to the invention, these two phases are at least partially concomitant.

The acquisition phase comprises a predetermined number nx of cycles for charging the storage capacitor Cs, this capacitor being discharged at the beginning of the acquisition phase. If no user is present near the sensor, the storage capacitor Cs is charged with a nominal charge defining a nominal storage voltage Vs_nom at the terminals of the storage capacitor Cs. This sensor is called a “low consumption linear charge-transfer sensor”.

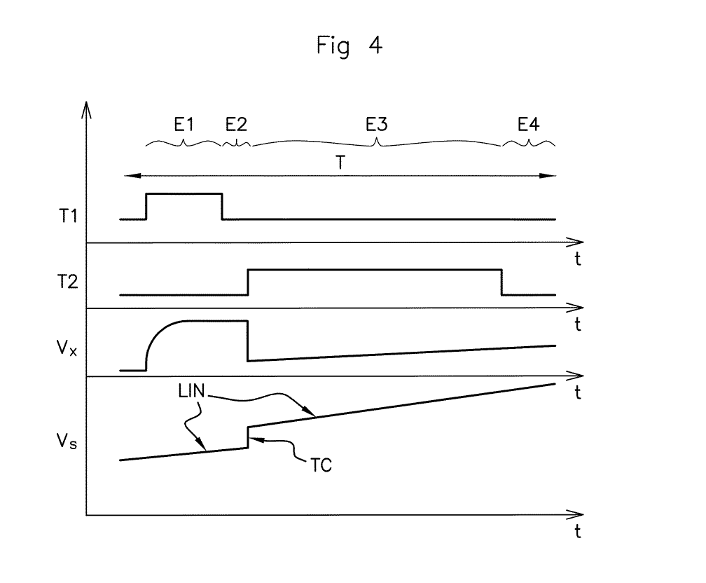

With reference to FIG. 4, a cycle continues for a time T, and comprises four steps providing a linear charge transfer between the voltage generator Vcc and the storage capacitor Cs via the detection capacitor Cx. In the initial state of the circuit, the first switch T1 and the second switch T2 are open.

In a first step E1, called the charge step, the first switch T1 is closed, enabling the detection capacitor Cx to be charged by the voltage generator Vcc.

In a second step E2, called the rest step, the first switch T1 and the second switch T2 are open.

In a third step E3, called the discharge step, the second switch T2 is closed, enabling the charge to be transferred TC by current conduction from the detection capacitor Cx to the storage capacitor Cs.

Finally, in a fourth, rest step E4, the first switch T1 and the second switch T2 are open.

According to the invention, as shown in FIG. 4, the measurement phase takes place at the same time as the acquisition phase. Thus the storage capacitor Cs is charged continuously both by the charge transfer TC from the detection capacitor Cx and by linear charging LIN through the measuring resistor Rs, making it possible to reduce the overall measurement time and therefore the detection time of the sensor.

This charging of the storage capacitor Cs continues until the comparator indicates that the storage voltage Vs and the reference voltage Vref are equal, and the duration of the charging is measured.

If the sensor comprises a digital-analog converter (abbreviated to DAC in English), this digital-analog converter can be used to determine the reference voltage Vref dynamically, in such a way that this voltage is always greater than the storage voltage Vs at the end of the predetermined number nx of discharges of the detection capacitor Cx into the storage capacitor Cs. Advantageously, this value of the reference voltage Vs can be set so that the difference between the reference voltage Vref and the storage voltage Vs, after the predetermined number nx of discharges, is less than 100 mV.

If no user is present near the sensor during the acquisition and measurement phases, the time measured between the instant of the start of the first cycle of the acquisition phase and the instant when the storage voltage Vs reaches the reference voltage Vref is equal to a nominal time Tnom. In other words, if there is no detection, the storage voltage Vs reaches the reference voltage Vref after a nominal time Tnom. Thus, if the storage capacitor Cs has been charged for a predetermined number nx of cycles, this means that no user has approached the sensor, the charge of the storage capacitor Cs at the end of the acquisition phase then being equal to a nominal charge value, and the storage voltage Vs at the terminals of the storage capacitor Cs then being equal to a nominal storage voltage Vs_nom.

On the other hand, if a user is present near the sensor in the acquisition and measurement phases, the capacitance of the detection capacitor Cx increases, and therefore the number y of cycles required for the storage voltage Vs to reach the reference voltage Vs is less than the predetermined number nx of cycles. In other words, the time measured between the instant of the start of the first cycle of the acquisition phase and the instant when the storage voltage Vs reaches the reference voltage Vref is equal to a detection time Tdet which is less than the nominal time Tnom (i.e. the storage voltage Vs reaches the reference voltage Vref more rapidly).

Since a user has been detected, the sensor sends a detection signal to an electronic computer of the vehicle, referred to in a known way as an ECU (Electronic Control Unit in English), which then unlocks the corresponding access to the vehicle, after authentication if required.

Therefore, by executing the measurement phase at the same time as the acquisition phase, that is to say from the beginning instead of one after the other, it is possible to achieve a gain in the acquisition time and therefore in the detection time, advantageously resulting in the faster unlocking of the access to the vehicle and lower electrical energy consumption of the sensor.

Finally, it should be noted that the present invention is not limited to the examples described above and can be varied in numerous ways within the capacity of those skilled in the art.

1. A method for using a sensor (1) to detect a user's presence for unlocking an access to a motor vehicle, said sensor (1) comprising:
a generator of a supply voltage (Vcc),
a first electrical circuit (A2) comprising a capacitor (Cx) for detecting a user's presence, which defines a detection voltage (Vx) at its terminals, a storage capacitor (Cs) which defines a storage voltage (Vs) at its terminals, means for controlling the charging of the detection capacitor (Cx) using the supply voltage (Vcc), means for controlling the discharging of the detection capacitor (Cx) into the storage capacitor (Cs), and means for calibrating a charging current of the storage capacitor (Cs) generated using the supply voltage (Vcc),
a second electrical circuit (B2) comprising a reference capacitor (Cref) defining a reference voltage (Vref) at its terminals and a bridge circuit for dividing the supply voltage (Vcc) into the reference voltage (Vref),
means (COMP) for comparing said storage voltage (Vs) and said reference voltage (Vref) in order to detect a user's presence for unlocking an access to the motor vehicle,
said method comprising an acquisition phase during which a step (E1) of charging the detection capacitor (Cx) and a step (E3) of discharging said detection capacitor (Cx) into the storage capacitor (Cs) are repeated successively for a predetermined number nx of times, and a measurement phase comprising a step of charging the storage capacitor (Cs) using the supply voltage (Vcc),
wherein the acquisition phase and the measurement phase are concomitant.

2. The method as claimed in claim 1, wherein, when the sensor (1) comprises a digital-analog converter, the method comprises a step in which the reference voltage (Vref) is determined by said digital-analog converter, in such a way that this voltage is always greater than the storage voltage (Vs) at the end of the predetermined number nx of discharges of the detection capacitor (Cx) into the storage capacitor (Cs).

3. The method as claimed in claim 1, wherein the difference between the reference voltage (Vref) and the storage voltage (Vs), after the predetermined number nx of discharges, is less than 100 mV.

4. A sensor (1) for detecting a user's presence for unlocking an access to a motor vehicle, said sensor comprising:
a generator of a supply voltage (Vcc),
a first electrical circuit (A2) comprising a capacitor (Cx) for detecting a user's presence, which defines a detection voltage (Vx) at its terminals, a storage capacitor (Cs) which defines a storage voltage (Vs) at its terminals, means for controlling the charging of the detection capacitor (Cx) using the supply voltage (Vcc), means for controlling the discharging of the detection capacitor (Cx) into the storage capacitor (Cs), and means for calibrating a charging current of the storage capacitor (Cs) generated using the supply voltage (Vcc),
a second electrical circuit (B2) comprising a reference capacitor (Cref) defining a reference voltage (Vref) at its terminals and a voltage divider bridge circuit for dividing the supply voltage (Vcc) into the reference voltage (Vref),
means (COMP) for comparing said storage voltage (Vs) and said reference voltage (Vref) in order to detect a user's presence for unlocking an access to the motor vehicle,
wherein the calibration means take the form of a measuring resistor (Rs), continuously connected electrically, on the one hand, to the generator of the supply voltage (Vcc), and, on the other hand, to the storage capacitor (Cs).

5. The sensor (1) as claimed in claim 4, further comprising a digital-analog converter configured to determine the reference voltage (Vref) in such a way that this voltage is always greater than the storage voltage (Vs) at the end of the predetermined number nx of discharges of the detection capacitor (Cx) into the storage capacitor (Cs).

6. A motor vehicle comprising a sensor (1) as claimed in claim 4.

7. A motor vehicle comprising a sensor (1) as claimed in claim 5.
